(19) United States
(12) Patent Application Publication
(10) Pub. No.: US 2008/0173786 A1
(43) Pub. Date: Jul. 24, 2008

(54) Injection Mold Including a Quick-Change Mold Assembly

(75) Inventors: Chih-Yu Chen, Taipei Hsien (TW); Jian-Guang Huang, Taipei Hsien (TW); Yun-Qing He, Taipei Hsien (TW); Chun-Yan Wu, Taipei Hsien (TW); Lin-Chong Zhu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/626,210

(22) Filed: Jan. 23, 2007

(51) Int. Cl. B41B 11/62

(52) U.S. Cl. 249/102

(57) ABSTRACT

An injection mold including a quick-change mold assembly has a stationary platen, a mold, a core, a spring and a plurality of blots. The stationary platen has a plurality of inserting holes defined at two side laterals and a plurality of first fixing holes defined at the said laterals besides a rear lateral. The mold has a chamber, a plurality of inserting apertures and second fixing holes. The inserting apertures are corresponding to the inserting holes. The second fixing holes are corresponding to the first fixing holes. The core is placed in the chamber of the mold. The springs are located in the inserting apertures. A plurality of bolts used for anchoring the mold and the core to the stationary platen are located in the first fixing hole and the second fixing hole.

### BACKGROUND OF THE INVENTION

1. Field of the Invention

This present invention generally relates to a mold, and more particularly to an injection mold including a quick-change mold assembly.

2. The Related Art

In production, when a core is needed to change for another one, the user has to complete the core-changing process with external tools first to locate the core in the injection mold.

Traditionally, an injection mold includes a stationary platen, a fastening and a mold. The stationary platen has a T-shaped recess and a hole formed in a certain position. The hole runs through the stationary platen. Another contained hole is formed on the mold corresponding to the aforesaid hole. The mold has a cavity carved on the surface of the mold. The cavity is used for shaping products. A T-shaped cam is projected at the back of the mold. The T-shaped cam is received in the T-shaped recess rigidly. The T-shaped cam matches well with the T-shaped recess. The fastening is fixed in the stationary platen.

At the beginning of assemblage, one end of the T-shaped cam is set on a related end of the T-shaped recess to make sure that the connecting portion of the T-shaped cam matches well with the T-shaped recess. Then the user pushes the mold to the other end along the T-shaped recess on the stationary platen. When the mold moves for a predetermined distance, the hole and the contained hole are arranged straightly. Meanwhile, the upper of the fastening is away from the resistance, so the fastening stretches upwards to insert into the contained hole of the mold. According to the fastening, the stationary platen and the mold are properly located at this time.

However, the stationary platen and the mold match precisely in the injection mold. The size of the T-shaped cam and the T-shaped recess should meet closely. In other words, the T-shaped recess has not enough external space for receiving the T-shaped cam. If the T-shaped recess is bigger than the T-shaped cam, so the mold cannot be fixed on the stationary platen by this way of locking. If the T-shaped recess is smaller than the T-shaped cam, it is appearance that the T-shaped cam of the mold cannot be contained in the T-shaped recess. In addition, the mold is bulky. As a result, it brings a lot of trouble for setting the mold on the stationary platen. Moreover, a strong friction produces between the T-shaped cam and the T-shaped recess while the mold is moving from one end to the other end, so the user pushes the mold difficultly. The traditional injection mold generates the work time to be wasted and the production costs to increase. Meanwhile, the traditional injection mold maybe wound the user. What is more, for some time, the mold and the stationary platen will be abraded. All of the aforesaid flaws point that the design is not suitable for changing mold.

### SUMMARY OF THE INVENTION

Accordingly, an object of the present invention is to provide an injection mold including a quick-change mold assembly. The injection mold including the quick-change mold assembly has a stationary platen, a mold, a core, a spring, fixing bars and a plurality of blots. The stationary platen has a plurality of inserting holes defined on two side laterals and a plurality of first fixing holes defined on the said laterals besides a rear lateral. The inserting holes are located between the fixing holes. The mold has a chamber, a plurality of inserting apertures and second fixing holes. The inserting apertures are located between the second fixing holes. The inserting apertures and the second fixing holes surround the chamber. The inserting apertures are corresponding to the inserting holes. The second fixing holes are corresponding to the first fixing holes. The core is received in the chamber of the mold. The springs are located in the inserting apertures. The top surfaces of the springs are pressed by the mold and the under surfaces of the springs are supported by the stationary platen. The fixing bars run through the inserting apertures and are located in the inserting holes. The springs sleeve on the fixing bars. A plurality of bolts used for anchoring the mold and the core to the stationary platen are located in the first fixing holes and the second fixing holes.

When the user has to change the core for another one, the user removes the bolts first. Without external power, the spring releases and pushes the mold upwards for a certain distance. The mold is separated from the core. The friction produced between the mold and the core is disappeared. The user pulls the core out easily. Thereby, the design of the injection mold including the quick-change mold assembly is suitable for changing cores, saving work time, cutting production costs and improving efficiency.

### BRIEF DESCRIPTION OF THE DRAWINGS

The present invention will be apparent to those skilled in the art by reading the following description of a preferred embodiment thereof, with reference to the attached drawings, in which:

FIG. 1 is an explored view of an injection mold including a quick-change mold assembly of the present invention;

FIG. 2 is a cross-section view through lines II-II of FIG. 1;

FIG. 3 is a perspective view of the injection mold including the quick-change mold assembly;

FIG. 4 is a cross-section view through lines IV-IV of FIG. 3;

FIG. 5 is a perspective view of a mold of the injection mold including the quick-change mold assembly sprigged upwards; and

FIG. 6 is a cross-section view through lines VI-VI of FIG. 5.

### DETAILED DESCRIPTION OF THE PREFERRED EMBODIMENT

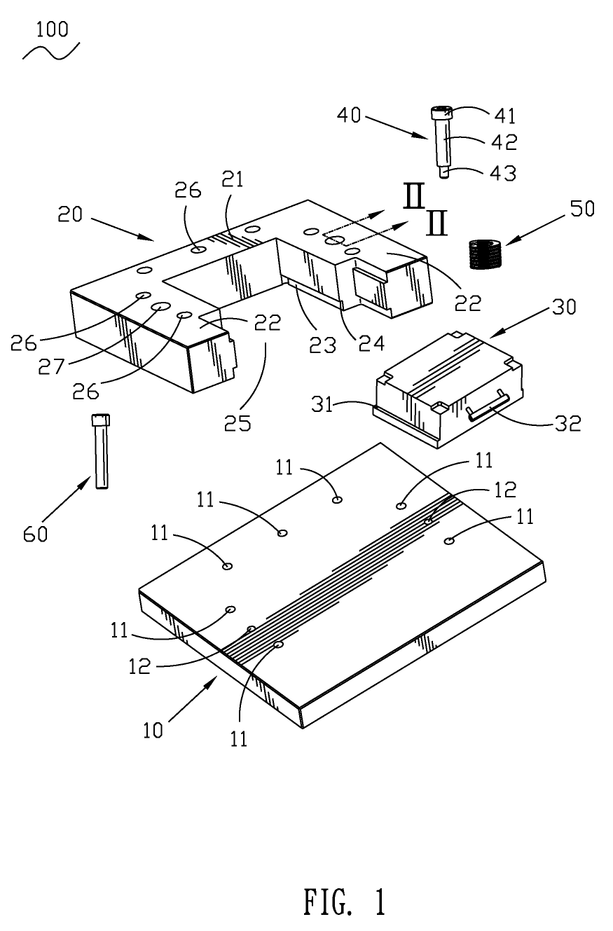

Referring to FIG. 1, an injection mold including a quick-change mold assembly 100 includes a stationary platen 10, a mold 20, a core 30, a fixing bar 40, a spring 50 and a bolt 60. The stationary mold 10 is flat. A plurality of first fixing holes 11 are defined on two side laterals besides the rear lateral of the stationary platen 10. A plurality of inserting holes 12 are defined on the two side laterals and located between the first fixing holes 11. The mold 20 has a resisting wall 21 and two guiding walls 22. The guiding walls 22 extend forwards from two ends of the resisting wall 21. All the walls 21, 22 surround a chamber 25. The guiding walls 22 have two guiding recesses 23 excavated at the foot of the guiding walls 22. The guiding recesses 23 are located on the inner of the guiding walls 22 and connect with the chamber 25. Meanwhile, two pressing portions 24 are formed beneath the guiding walls 22 and the pressing portions 24 are located at the upper of the guiding recesses 23. The mold 20 has a plurality of second fixing holes 26 and inserting apertures 27. The second fixing holes 26 are defined in the resisting wall 21 and the guiding walls 22. The inserting apertures 27 are defined in the guiding walls 22 and located between the second fixing holes 26. The inserting apertures 27 are corresponding to the inserting holes 12. The second fixing holes 26 are corresponding to the first fixing holes 11.

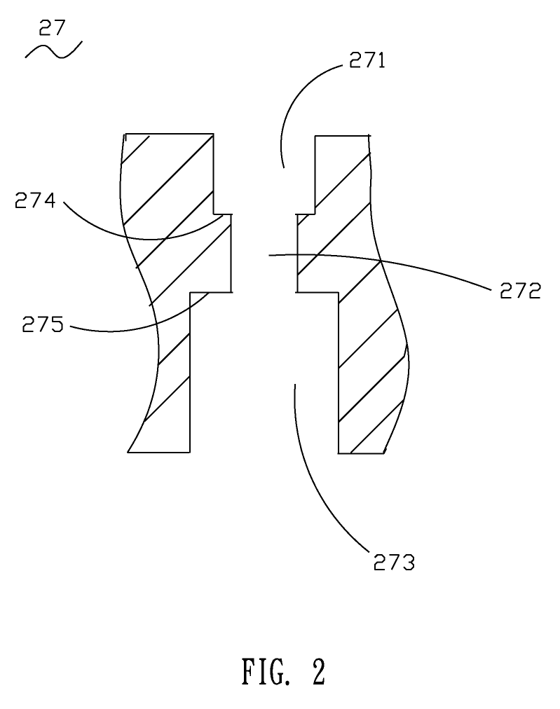

Please refer to FIG. 2. The inserting aperture 27 has an operation holding room 271, a connecting room 272 and a spring holding room 273. The diameter of the operation holding room 271 is bigger than the diameter of the connecting room 272, so a first resisting surface 274 is formed between the operation holding room 271 and the connecting room 272. The diameter of the spring holding room 273 is bigger than the diameter of the connecting room 272, so a second resisting surface 275 is formed between the connecting space 272 and the spring holding room 273.

Please continue referring to FIG. 1. The core 30 is received in the chamber 25. The core 30 has sliding blocks 31. The sliding blocks 31 project outwards at the foot of the core 30 and the sliding blocks 32 are received in the guiding recess 23. The pressing portions 24 press the sliding blocks 31 downwards. A handle 32 is assembled on the front of the core 30 for conveniently taking out the core 30. The fixing bar 40 has three portions. The top is an operating portion 41, the middle is a connecting portion 42 and the below is an inserting portion 43. The diameter of the operating portion 41 is slightly smaller than the diameter of the operation holding room 271. The diameter of the connecting portion 42 is slightly smaller than the connecting room 272. The diameter of the inserting portion 43 is equal to the diameter of the inserting holes 12. The inserting portion 43 engages with the inserting hole 12. The spring 50 is placed in the spring holding room 273. The spring 50 is compressed in the injection mold including the quick-change mold assembly 100. The upper surface of the spring 50 resists the mold 20 upwards. The lower of the spring 50 is supported by the stationary platen 10. The bolts 60 used for anchoring the mold 20 and the core 30 to the stationary platen 10 run through the second fixing holes 26 and are locked in the first fixing holes 11.

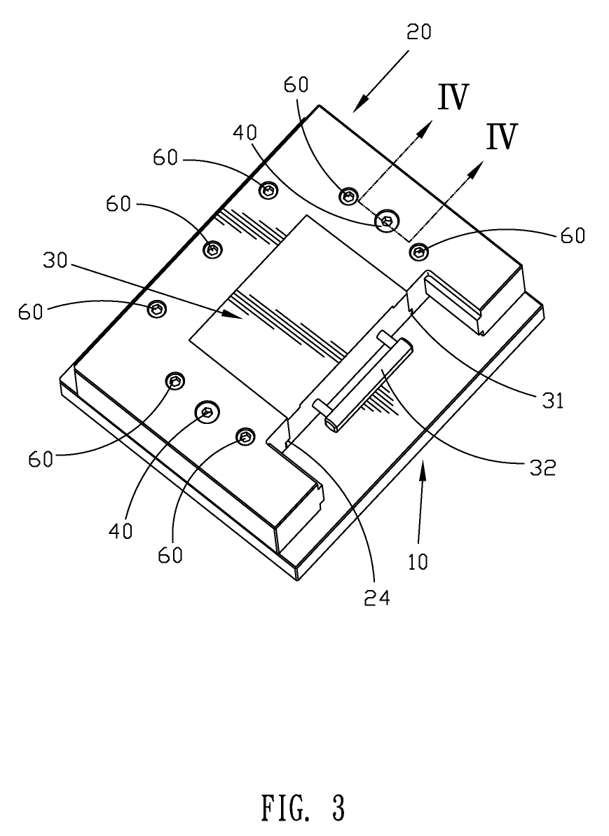

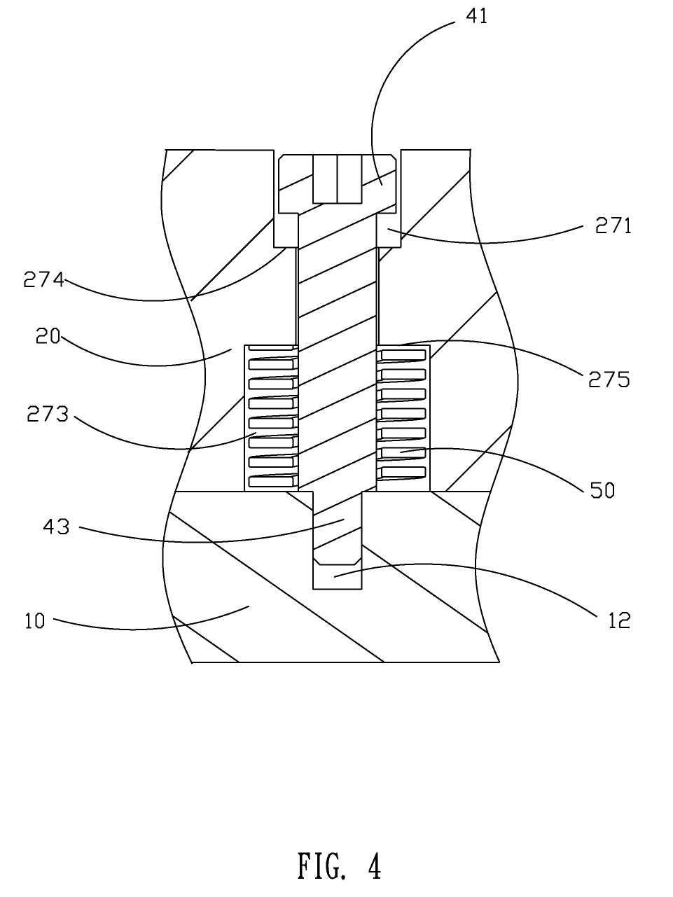

Please refer to FIG. 3 in conjunction with FIG. 4. Firstly, the user has to put the spring 50 in the spring holding room 273 of the mold 20. Secondly, the user has to cover the mold 20 on the stationary platen 10. The mold 20 is set on the surface of the stationary platen 10. The spring 50 is compressed and produces an upward push on the second resisting surface 275. The length of the spring 50 loaded the mold 20 are longer than the deep of the spring holding room 273. Thirdly, the user has to set the core 30 into the chamber 25 and the sliding blocks 31 of the core 30 are about to receive in the guiding recesses 23. The user then pushes the core 30 backwards along the guiding recesses 23 until the back of the core 30 relies on the resisting wall 21. Fourthly, the user presses the mold 20 moving downwards until the mold 20 touches with the stationary platen 10. The pressing portion 24 presses downwards on the sliding blocks 31. At last, the mold 20 and the core 30 are secured or anchored to the stationary platen 10 by a set of bolts 60 which extend through the first fixing holes 11 and the second fixing holes 26. After the mold 20 and the core 30 are located on the stationary platen 10, the user inserts the fixing bar 40 into the inserting apertures 27. The fixing bars 40 run through the inserting apertures 27 and The inserting portion 43 of the fixing bar 40 is fixed rigidly on the inserting hole 12. The upper surface of the fixing bar 40 and the mold 20 are on a same horizontal. The operating portion 41 of the fixing bar 40 has a certain distance from the first resisting surface 274.

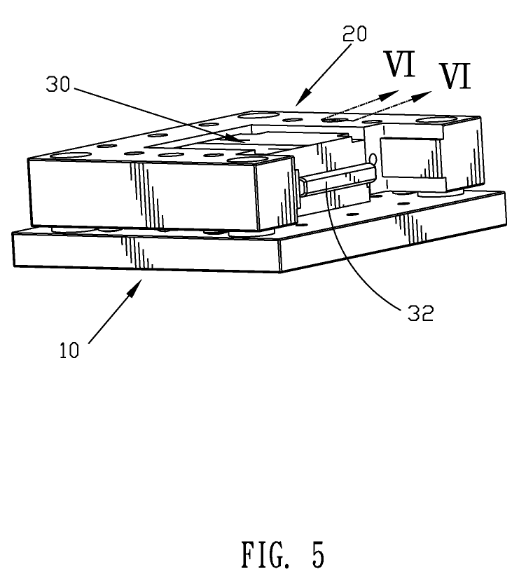

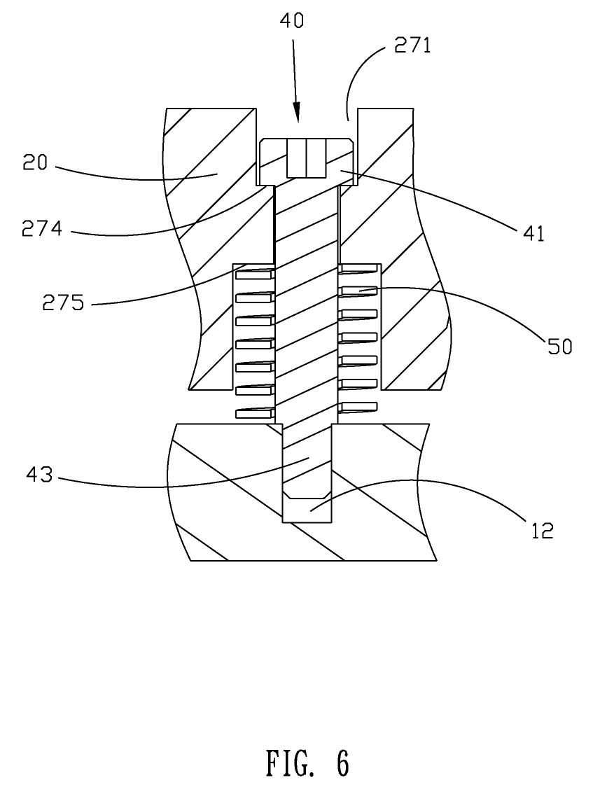

Please refer to FIGS. 5-6 and FIG. 1. When the user has to change the core 30 for another one, the user has to remove the bolts 60 first. Without external power, the spring 50 releases and pushes the mold upwards on the second resisting surface 275. The elastic force is stronger than the weight of the mold 20, so the mold 20 is raised up for a certain distance. The first resisting surface 274 resists on the back of the operating portion 41 of the fixing bar 40. The mold 20 is separated from the core 30. The friction produced between the mold 20 and core 30 is disappeared. The user pulls the handle 32 of the core 30 outwards and draws out the core 30 easily.

An embodiment of the present invention has been discusses in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. An injection mold including a quick-change mold assembly, comprising:
a stationary platen having a plurality of inserting holes defined on two side laterals and a plurality of first fixing holes defined on the said laterals besides a rear lateral, the inserting holes located between the fixing holes;
a mold having a chamber, a plurality of inserting apertures and second fixing holes, the second fixing holes defined in the resisting wall and the guiding walls, the inserting apertures defined in the guiding walls and located between the second fixing holes, the inserting apertures and the second fixing holes surrounding the chamber, the inserting apertures located between the second fixing holes, the inserting apertures corresponding to the inserting hole, the second fixing holes corresponding to the first fixing hole;
a core received in the chamber of the mold;
a spring located in the inserting aperture, the top surface of the spring pressed by the mold, the under surface of the spring supported by the stationary platen;
a fixing bar being run through the inserting aperture and located in the inserting hole; and
a plurality of bolts used for anchoring the mold and the core to the stationary platen being located in the first fixing hole and the second fixing hole.

2. The injection mold including a quick-change mold assembly as claimed in claim 1, further comprising a resisting wall and guiding walls, the guiding walls extending forwards form two ends of the resisting wall, the chamber defined by all the walls, guiding recesses excavated at the foot of the guiding walls, pressing portions formed beneath the guiding walls and located on the upper of the guiding recesses.

3. The injection mold including a quick-change mold assembly as claimed in claim 2, further comprising a sliding block projecting at the foot of the core, the sliding blocks contained in the guiding recesses, the sliding blocks pressed by the pressing portions.

4. The injection mold including a quick-change mold assembly as claimed in claim 3, further comprising a handle assembled on the front of the core.

5. The injection mold including a quick-change mold assembly as claimed in claim 1, wherein the inserting apertures have an operation holding room, a connecting room and a spring holding room in vertical.

6. The injection mold including a quick-change mold assembly as claimed in claim 5, wherein the fixing bar has an operating portion, a connecting portion and a inserting portion in vertical, the fixing bar is used for positioning the mold and the stationary platen.

7. The injection mold including a quick-change mold assembly as claimed in claim 6, wherein the diameter of the operating portion is slightly smaller than the diameter of the operation holding room, the diameter of the connecting portion is lightly smaller than the diameter of the connecting room, the diameter of the inserting portion is equal to diameter of the inserting hole.

8. The injection mold including a quick-change mold assembly as claimed in claim 6, wherein the inserting portion extends from the bottom of the connecting portion.

9. The injection mold including a quick-change mold assembly as claimed in claim 6, further comprising a first resisting surface formed between the operating holding room and the connecting holding room, the operating portion of the fixing bar has a certain distance from the first resisting surface.
